(19) United States
(12) Patent Application Publication
(10) Pub. No.: US 2012/0223558 A1
(43) Pub. Date: Sep. 6, 2012

(54) CHILD CAR SEAT

(76) Inventor: Jui-Lu Wang, Kowloon (HK)

(21) Appl. No.: 13/410,268

(22) Filed: Mar. 1, 2012

Related U.S. Application Data
(60) Provisional application No. 61/449,057, filed on Mar. 3, 2011.

(51) Int. Cl. B60N 2/26

(52) U.S. Cl. 297/250.1

(57) ABSTRACT

A child car seat includes a seat member and a head rest device. The head rest device includes a main body and a top protection structure. The main body is connected to a top of the seat member. The top protection structure is located above the main body for protecting a top of a head of a child seated on the seat member.

### CROSS REFERENCE TO RELATED APPLICATIONS

This application claims the benefit of U.S. provisional application No. 61/449,057, filed on Mar. 3, 2011 and incorporated herein by reference.

### BACKGROUND OF THE INVENTION

1. Field of the Invention

The present invention relates to a child car seat, and more particularly, to a child car seat capable of preventing a head of a child from hitting a roof of a car upwardly when a car accident occurs.

2. Description of the Prior Art

Since a child is smaller than an adult, the child can not fit a car seat designed for the adult. When the child is seated in the car, it requires an additional child car seat installed on the car seat for the child to be seated in the car comfortably.

A conventional child car seat is equipped with a head rest device for providing a head of the child with support. Generally speaking, the head rest device can only provide lateral protection when a car accident occurs. However, it can not prevent the head of the child from hitting a roof of the car upwardly when the car accident occurs. As a result, the conventional child car seat still has some drawbacks of safety issue.

### SUMMARY OF THE INVENTION

Thus, the present invention provides a child car seat capable of preventing a head of a child from hitting a roof of a car upwardly when a car accident occurs for solving above drawbacks.

According to the claimed invention, a child car seat includes a seat member and a head rest device. The head rest device includes a main body and a top protection structure. The main body is connected to a top of the seat member. The top protection structure is located above the main body for protecting a top of a head of a child seated on the seat member.

According to the claimed invention, the top protection structure protrudes forwardly from the main body, so as to be located above the head of the child.

According to the claimed invention, the child car seat further includes a lateral protection structure protruding forwardly from both sides of the main body. The main body, the top protection structure and the lateral protection portion cooperatively form a containing space for containing the head of the child.

According to the claimed invention, the top protection portion and the lateral protection portion are connected to one another, so as to form the containing space.

According to the claimed invention, the lateral protection structure and the top protection structure are integrally formed.

According to the claimed invention, the top protection structure is connected to the lateral protection structure in a screwing, wedging or tight fit manner.

According to the claimed invention, the lateral protection structure and the top protection structure are made of shock absorption material, respectively.

According to the claimed invention, the head rest device is disposed on the seat member in a slidable manner.

According to the claimed invention, the child car seat further includes a first sliding structure and a second sliding structure. The first sliding structure is disposed on a side of the seat member. The second sliding structure is disposed on the lateral protection structure for cooperating with the first sliding structure, such that the head rest device is slidably disposed on the seat member.

According to the claimed invention, the first sliding structure is a sliding slot, and the second sliding structure is a protruding post.

According to the claimed invention, the seat member includes a seat portion and a back rest portion connected to the seat portion, and the child car seat further includes a sliding mechanism disposed between the back rest portion of the seat member and the head rest device for sliding the head rest device relative to the seat member.

According to the claimed invention, the sliding mechanism further includes a track structure and a sliding member. The track structure is disposed on the back rest portion of the seat member. The sliding member is connected to the main body for cooperating with the track structure, such that the head rest device slides relative to the back rest portion.

According to the claimed invention, the track structure is a slot-shaped structure.

According to the claimed invention, the sliding mechanism further includes a first engaging member and a second engaging member. The first engaging member is disposed on the back rest portion of the seat member, and includes a plurality of positioning slots formed on different heights for the back rest. The second engaging member is connected to the sliding member for rotatably engaging with one of the plurality of positioning slots, so as to secure the head rest device relative to the seat member at a correspondent height.

According to the claimed invention, the second engaging member includes two driving members and an engaging rod. The two driving members are respectively connected to the sliding member in a rotatable manner. Both ends of the engaging rod are connected to the two driving members for engaging with one of the plurality of positioning slots.

According to the claimed invention, the sliding mechanism further includes an operating member connected to the second engaging member for driving the engaging rod to separate form the positioning slot, so as to release the second engaging member form the first engaging member.

In summary, the child car seat of the present invention is equipped with a top protection structure disposed above the head of the child for preventing the head of the child from hitting the roof of the car upwardly when the car accident occurs, so as to prevent damages. Furthermore, the lateral protection structure and the top protection structure are respectively made of the shock absorption material for absorbing impact to the head of the child, the lateral protection structure and the top protection structure when the car accident occurs, so as to provide the head of the child with further protection. Accordingly, the child car seat of the present invention is not only equipped with the top protection structure for preventing the head of the child from hitting the roof of the car upwardly, but also utilizes the shock absorption material to absorb the impact to the head of the child, the lateral protection structure and the top protection structure when the car accident occurs, so as to enhance safety of the child car seat.

These and other objectives of the present invention will no doubt become obvious to those of ordinary skill in the art after reading the following detailed description of the embodiment that is illustrated in the various figures and drawings.

### BRIEF DESCRIPTION OF THE DRAWINGS

FIG. 1 is a diagram of a child car seat according to a preferred embodiment of the present invention.

FIG. 2 is a diagram of the child car seat in another view according to the preferred embodiment of the present invention.

FIG. 3 is a diagram of a child car seat according to another preferred embodiment of the present invention.

FIG. 4 is a diagram of the child car seat in another view according to another embodiment of the present invention.

FIG. 5 is a diagram of a head rest device and a sliding mechanism according to another embodiment of the present invention.

### DETAILED DESCRIPTION

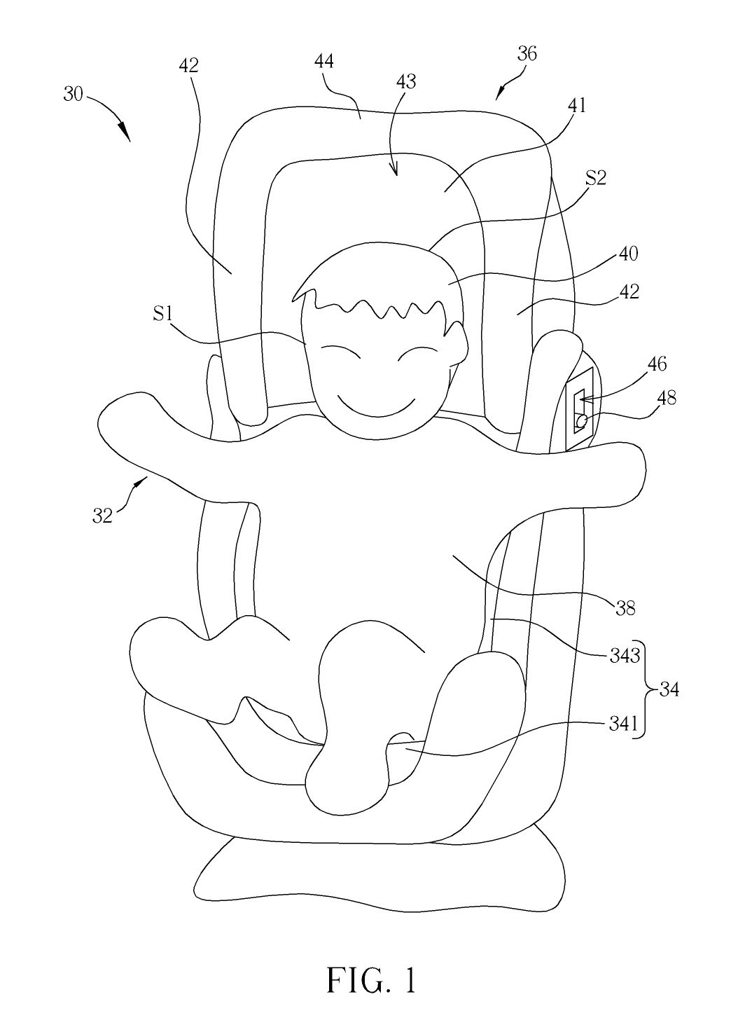

Please refer to FIG. 1. FIG. 1 is a diagram of a child car seat 30 according to a preferred embodiment of the present invention. In practical application, the child car seat 30 is designed for a child 32 to be seated in the car when the child 32 travels by the car. As shown in FIG. 1, the child car seat 30 includes a seat member 34 and a head rest device 36. The seat member 34 is used for holding a body 38 of the child 32, and the head rest device 36 is used for protecting a head 40 of the child 32.

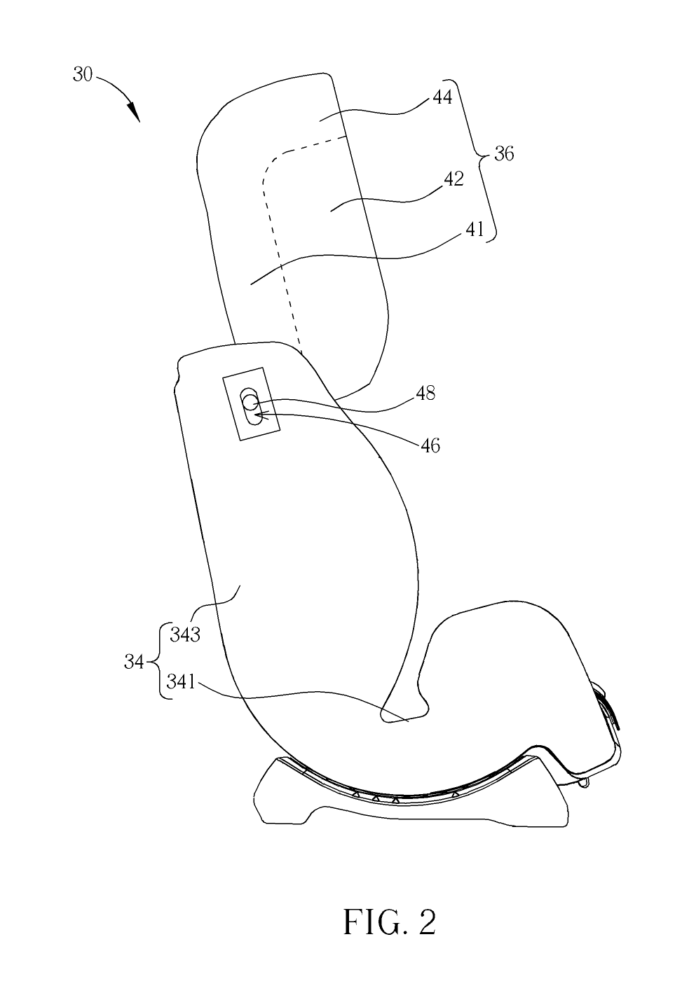

Please refer to FIG. 1 and FIG. 2. FIG. 2 is a diagram of the child car seat 30 in another view according to the preferred embodiment of the present invention. As shown in FIG. 1 and FIG. 2, the head rest device 36 includes a main body 41, a lateral protection structure 42 and a top protection structure 44. The main body 41 is connected to an upper portion of the seat member 34. The lateral protection structure 42 is protruded forwardly from two sides of the main body 41. The top protection structure 44 is located above the main body 41 and protrudes forwardly from the main body 41. The main body 41, the lateral protection structure 42 and the top protection structure 44 cooperatively form a containing space 43 for containing the head 40 of the child 32.

In such a manner, the lateral protection structure 42 is utilized for protecting a side portion S1 of the head 40 of the child 32, as shown in FIG. 1. When the child 32 is seated in the child car seat 30, the top protection structure 44 is located above a top portion S2 of the head 40 of the child 32, as shown in FIG. 1. When a car accident occurs, the top protection structure 44 is capable of preventing the head 40 of the child 32 from hitting a roof of the car upwardly, so as to protect the top portion S2 of the head 40 of the child 32. In this embodiment, the main body 41, the lateral protection structure 42 and the top protection structure 44 can be, but not limited to, connected to one another in a perpendicularly-oriented manner. For example, the main body 41, the lateral protection structure 42 and the top protection structure 44 can be connected to one another in an arc-shaped manner. As for adopting which one of the above-mentioned designs, it depends on practical demands.

In this embodiment, the lateral protection structure 42 and the top protection structure 44 can be, but not limited to, preferably integrally formed. For example, the lateral protection structure 42 and the top protection structure 44 can also be two separate components. As being in use, the top protection structure 44 can be fixed onto the lateral protection structure 42 by additional screws in a screwing manner, so as to connect the top protection structure 44 to the lateral protection structure 42. Alternatively, the top protection structure 44 can be fixed onto the lateral protection structure 42 in a wedging or in a tight fit manner, so as to connect the top protection structure 44 to the lateral protection structure 42. As for adopting which one of the above-mentioned designs, it depends on practical demands.

In practical application, the lateral protection structure 42 and the top protection structure 44 can be respectively made of shock absorption material, such as Hytrel, Expandable Polystyrene (EPS), Expandable Polypropylene (EPP), Expanded Polyolefin (EPO), spongy materials and so on. When the car accident occurs, the above-mentioned shock absorption materials can absorb an impact to the head 40 of the child 32, so as to enhance safety of the child car seat 30.

In this embodiment, the seat member 34 includes a seat portion 341 and a back rest portion 343 connected to the seat portion 341. In practical application, the child car seat 30 further includes a first sliding structure 46 and a second sliding structure 48. The first sliding structure 46 is disposed on a side of the seat member 34, and the second sliding structure 48 is disposed on the lateral protection structure 42. The first sliding structure 46 is capable of cooperating with the second sliding structure 48, such that the head rest device 36 is slidably disposed on the seat member 34. In such a manner, the first sliding structure 46 and the second sliding structure 48 can be desired to adjust a relative position between the head rest device 36 and the seat portion 341 of the seat member 34 for fitting children with different sizes, so as to enhance flexibility of the child car seat 30.

It should be noticed that design of structures connecting the head rest device 36 and the seat member 34 is not limited to those mentioned in the embodiment. For example, the lateral protection structure 42 and the seat member 34 can be integrally formed for saving manufacturing costs. As for adopting which one of the above-mentioned designs, it depends on practical demands. In this embodiment, the first sliding structure 46 can be, but not limited to, a sliding slot, and the second sliding structure 48 can be, but not limited to, a protruding post. On the other hand, the first sliding structure 46 and the second sliding structure 48 can also be, for example, a protruding post and a sliding slot, respectively. In other words, structures capable of sliding the head rest device 36 on the seat member 34 are within the scope of the present invention.

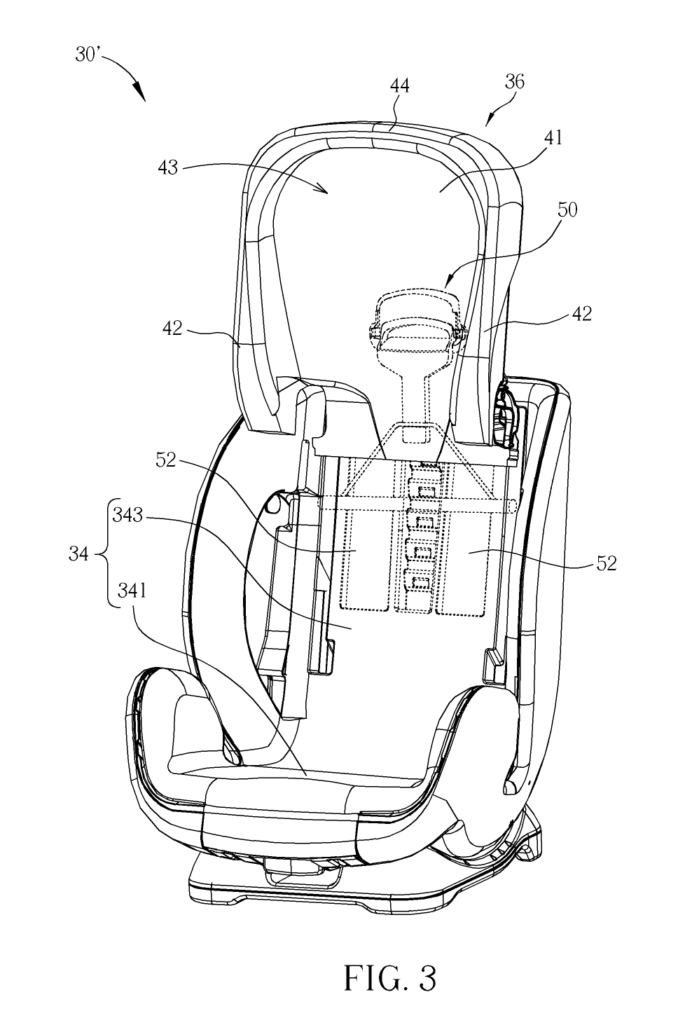

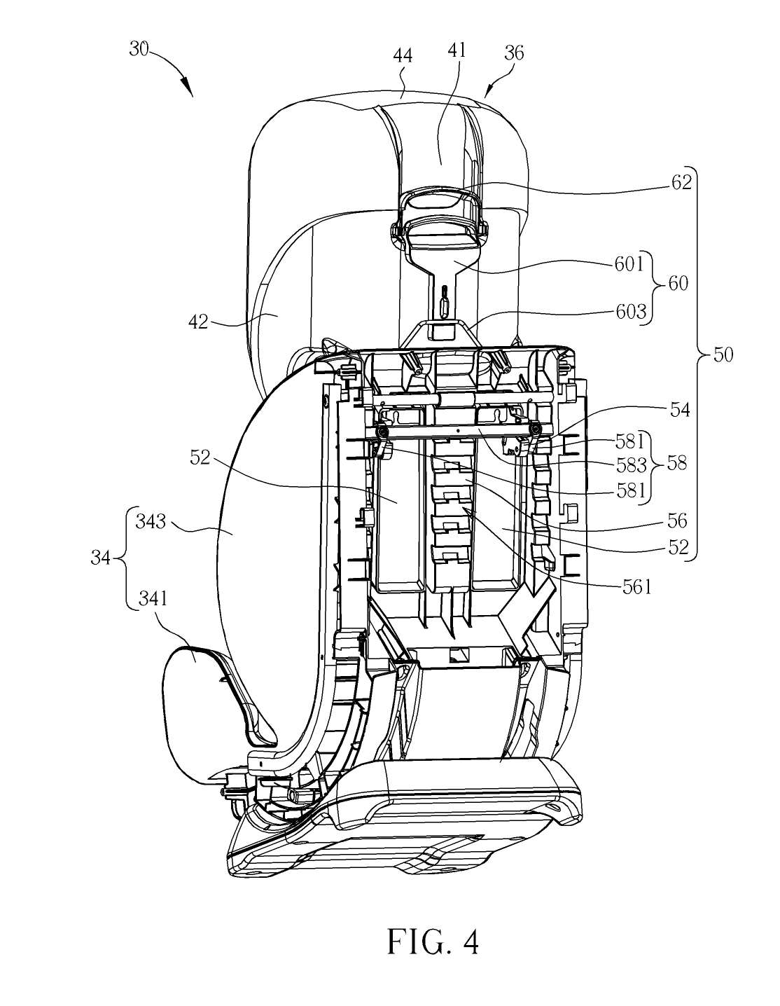

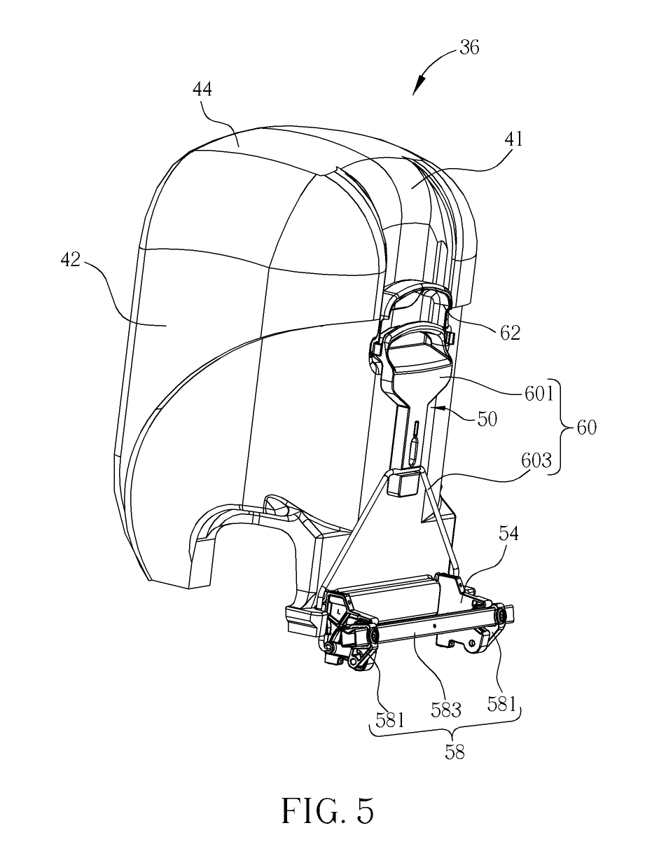

Please refer to FIG. 3. FIG. 3 is a diagram of a child car seat 30′ according to another preferred embodiment of the present invention. As shown in FIG. 3 and FIG. 1, the main difference between the child car seat 30′ and the aforesaid child car seat 30 is that the child car seat 30′ includes a sliding mechanism 50 disposed between the back rest portion 343 and the head rest device 36. Please refer to FIG. 4 and FIG. 5. FIG. 4 is a diagram of the child car seat 30′ in another view according to another embodiment of the present invention. FIG. 5 is a diagram of the head rest device 36 and the sliding mechanism 50 according to another embodiment of the present invention. As shown in FIG. 4 and FIG. 5, the sliding mechanism 50 includes a track structure 52 and a sliding member 54. The track structure 52 is disposed on the back rest portion 343 and is a slot-shaped structure. The sliding member 54 is connected to a back portion of the main body 41 of the head rest device 36. The sliding member 54 is utilized for cooperating with the track structure 52 for sliding the head rest device 36 relative to the seat member 34 along the track structure 52. Accordingly, the head rest device 36 is disposed on the seat member 34 in a slidable manner.

On the other hand, the sliding mechanism 50 is utilized for sliding the head rest device 36 on the seat member 34 in this embodiment. Accordingly, the height of the head rest device 36 relative to the seat member 34 can be desired to adjust by utilizing the track structure 52 and the sliding member 54 for fitting the children with different sizes, so as to enhance flexibility of the child car seat 30′. As shown in FIG. 4 and FIG. 5, the sliding mechanism 50 further includes a first engaging member 56 and a second engaging member 58. The first engaging member 56 is disposed on the back portion of the back rest portion 343 of the seat member 34. In this embodiment, the first engaging member 56 is located between the two track structures 52. The first engaging member 56 includes a plurality of positioning slots 561 that are formed to different heights of the back rest portion 343. The second engaging member 58 is connected to the sliding member 54 in a rotatable manner. The second engaging member 58 includes two driving members 581 and an engaging rod 583 with both ends respectively connected to the two driving members 581. Since the driving members 581 is pivoted to the sliding member 54, the engaging rod 583 of the second engaging member 58 is capable of rotatably engaging with one of the plurality of the positioning slots 561, so as to secure the head rest device 36 relative to the seat member 34 at a correspondent height, as shown in FIG. 4.

In addition, the sliding mechanism 50 further includes an operating member 60 connected to the second engaging member 58 for driving the engaging rod 583 to separate from the positioning slots 561, so as to release the second engaging member 58 from the first engaging member 56. In this embodiment, the operating member 60 includes an operating portion 601 and a connecting member 603. The operating portion 601 is connected to a top portion of the main body 41 of the head rest device 36. A middle portion of the connecting member 603 is connected to the operating portion 601, and both ends of the connecting member 603 are connected to the two driving members 581, respectively.

When the head rest device 36 is desired to adjust the relative position between the seat portion 341 of the seat member 34 and the head rest device 36, the operating member 60 is pulled first to drive the driving members 581 to rotate relative to the sliding member 54, such that the engaging rod 583 separates from one of the plurality of positioning slots 561. Then, the track structure 52 and the sliding member 54 are utilized for facilitating the adjustment the relative position between the head rest device 36 and the seat portion 341 of the seat member 34. Then, the operating member 60 is released for the engaging rod 583 to engage another one of the plurality of positioning slots 561, so as to fix the head rest device 36 at another height. In this embodiment, a handle portion 62 can be further disposed on the back portion of the main body 41 of the head rest device 36. The handle portion 62 is located above the operating portion 601 of the operating member 60, as shown in FIG. 5, for providing the user's fingers with place to apply force. Accordingly, it can enhance convenience for the user to adjust the height of the head rest device 36.

Compared to the prior art, the child car seat of the present invention is equipped with a top protection structure disposed above the head of the child for preventing the head of the child from hitting the roof of the car upwardly when the car accident occurs, so as to prevent damages. Furthermore, the lateral protection structure and the top protection structure are respectively made of the shock absorption material for absorbing impact to the head of the child, the lateral protection structure and the top protection structure when the car accident occurs, so as to provide the head of the child with further protection. Accordingly, the child car seat of the present invention is not only equipped with the top protection structure for preventing the head of the child from hitting the roof of the car upwardly, but also utilizes the shock absorption material to absorb the impact to the head of the child, the lateral protection structure and the top protection structure when the car accident occurs, so as to enhance safety of the child car seat.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A child car seat, comprising:
a seat member; and
a head rest device, comprising:
a main body connected to a top of the seat member; and
a top protection structure located above the main body for protecting a top of a head of a child seating on the seat member.

2. The child car seat of claim 1, wherein the top protection structure protrudes forwardly from the main body, so as to be located above the head of the child.

3. The child car seat of claim 2, further comprising:
a lateral protection structure protruding forwardly from both sides of the main body, and the main body, the top protection structure and the lateral protection portion cooperatively forming a containing space for containing the head of the child.

4. The child car seat of claim 3, wherein the main body, the top protection portion and the lateral protection portion are connected to one another, so as to form the containing space.

5. The child car seat of claim 3, wherein the lateral protection structure and the top protection structure are integrally formed.

6. The child car seat of claim 3, wherein the top protection structure is connected to the lateral protection structure in a screwing, wedging or tight fit manner.

7. The child car seat of claim 3, wherein the lateral protection structure and the top protection structure are made of shock absorption material, respectively.

8. The child car seat of claim 1, wherein the head rest device is disposed on the seat member in a slidable manner.

9. The child car seat of claim 8, further comprising:
a first sliding structure disposed on a side of the seat member; and
a second sliding structure disposed on the lateral protection structure for cooperating with the first sliding structure, such that the head rest device is slidably disposed on the seat member.

10. The child car seat of claim 9, wherein the first sliding structure is a sliding slot, and the second sliding structure is a protruding post.

11. The child car seat of claim 8, wherein the seat member comprises a seat portion and a back rest portion connected to the seat portion, and the child car seat further comprises:
a sliding mechanism disposed between the back rest portion of the seat member and the head rest device for sliding the head rest device relative to the seat member.

12. The child car seat of claim 11, wherein the sliding mechanism further comprises:
a track structure disposed on the back rest portion of the seat member; and
a sliding member connected to the main body for cooperating with the track structure, such that the head rest device slides relative to the back rest portion.

13. The child car seat of claim 12, wherein the track structure is a slot-shaped structure.

14. The child car seat of claim 12, wherein the sliding mechanism further comprises:
a first engaging member, disposed on the back rest portion of the seat member, including a plurality of positioning slots formed on different heights for the back rest; and
a second engaging member connected to the sliding member for rotatably engaging with one of the plurality of positioning slots, so as to secure the head rest device relative to the seat member at a correspondent height.

15. The child car seat of claim 14, wherein the second engaging member comprises:
two driving members respectively connected to the sliding member in a rotatable manner; and
an engaging rod with both ends connected to the two driving members for engaging with one of the plurality of positioning slots.

16. The child car seat of claim 15, wherein the sliding mechanism further comprises:
an operating member connected to the second engaging member for driving the engaging rod to separate form the positioning slot, so as to release the second engaging member form the first engaging member.
